(19) United States
(12) Patent Application Publication
(10) Pub. No.: US 2025/0333982 A1
(43) Pub. Date: Oct. 30, 2025

(54) NEW TYPE OF PROTECTIVE SLIDING DOOR

(71) Applicant: Guangzhou Sair Industrial Co.,Ltd, Guangzhou (CN)

(72) Inventor: JIYE GUO, Guangzhou (CN)

(21) Appl. No.: 18/812,082

(22) Filed: Aug. 22, 2024

(30) Foreign Application Priority Data
Apr. 29, 2024 (CN) 202420930612.X

(51) Int. Cl. E05B 65/08; E06B 9/00; E06B 9/04

(52) U.S. Cl. CPC E05B 65/0888; E06B 9/04; E06B 2009/002

(57) ABSTRACT

The present invention discloses a new type of protective sliding door and, during installation, the positioning mechanism and locking mechanism can be first fixedly installed in a predetermined position, and then the door railing body can be installed, the second connecting piece at the lower part of the pivot connection side of the door railing body can be flexibly connected to the lower part of the positioning mechanism, the connecting piece that can be installed on the first connecting piece can be fixedly assembled with the upper part of the positioning mechanism, so that the installed door railing body can open or close the door by swinging relative to the positioning mechanism and, after the door is closed, the locking mechanism can be connected to the locking side of the door railing body to lock the door railing body.

### CROSS-REFERENCE TO RELATED APPLICATIONS

This application claims priority to Chinese Patent Application No. 202420930612.X, filed on Apr. 29, 2024, which is hereby incorporated by reference in its entirety.

### TECHNICAL FIELD

The invention relates to the field of telescopic door railing technology, in particular to a new type of protective sliding door.

### BACKGROUND

In families with infants, in order to protect infants walking out of the room against accidents such as getting lost or personal injury, people often install a sliding door railing in positions like indoor corridors and stairwells, and the sliding door railing is mainly composed of two movably connected door bodies, the two sides of the sliding door railing are the pivot connection side and the locking side, respectively, and a hinge seat or other pivot connection structure is provided on the pivot connection side, one of the door bodies can be slid to make the two door bodies overlap or stagger so that the sliding door railing can be lengthened or shortened, and during installation, the length of door railing can be first adjusted according to the width of aisle, and then the hinge seat or other pivot structure on the pivot connection side of sliding door railing can be fixed to the wall, so that the sliding door railing can swing relative to the hinge seat or other pivot structure to disconnect or connect the aisle, and when the sliding door railing swings to the position where the aisle is disconnected, the sliding door railing can be locked by connecting the door railing lock fixed on another wall to the locking side of the sliding door railing.

Since the hinge seat or other pivot structures that are directly installed on the sliding door railing cannot be disassembled, during installation, two operators may be required for installation, one stabilizing the sliding door railing and the other fixing the hinge seat or other pivot structures on the wall using tools. Of course, installation can also be carried out by a single person, but it is more troublesome, because tools must be used for installation and fixation while the sliding door railing must be maintained at a correct position. During the process, installation errors may occur due to the insecure support for sliding door railing, resulting in poor installation efficiency and re-installation because of door tilting, too high or too low position. Therefore, the applicant improves the prior art and proposes a protective sliding door that can be easily and conveniently installed by a single person.

### SUMMARY

The main purpose of the invention is to propose a new type of protective sliding door, aiming to address the problems proposed in the background art mentioned above.

To achieve the above purposes, the invention proposes a new type of protective sliding door, including a door railing body, a locking mechanism located on the locking side of the door railing body, and a positioning mechanism located on the pivot connection side of the door railing body, the door railing body includes a first door body having the pivot connection side and a second door body having the locking side, the first door body and the second door body are movably connected, and the second door body can move between the position where it overlaps the first door body and the position where it is staggered from the first door body, and the first door body and second door body are both formed by a plurality of connected bar components and have a plurality of hollows, the upper and lower parts of the pivot connection side are respectively provided with a first connecting member and a second connecting member, and the second connecting member is detachably connected to the lower part of the positioning mechanism, the first connecting member can be pivotally provided with a connecting piece for detachable and fixed assembly with the upper part of positioning mechanism, the door railing body can perform horizontal swing relative to the positioning mechanism, and the locking side can, along with the swing of the door railing body, swing between the position where it is locked with the locking mechanism and the position where it is away from the locking mechanism.

For the technical solution of the invention, during installation, the positioning mechanism and locking mechanism can be first fixedly installed in a predetermined position, and then the door railing body can be installed, the second connecting piece at the lower part of the pivot connection side of the door railing body can be flexibly connected to the lower part of the positioning mechanism, the connecting piece that can be installed on the first connecting piece can be fixedly assembled with the upper part of the positioning mechanism, so that the installed door railing body can open or close the door by swinging relative to the positioning mechanism and, after the door is closed, the locking mechanism can be connected to the locking side of the door railing body to lock the door railing body; compared with traditional sliding doors, the present invention optimizes the installation process, and makes the single-person installation easy and convenient, free of re-installation, effectively improving the installation efficiency.

### BRIEF DESCRIPTION OF DRAWINGS

FIG. 1 is a 3D view of the present invention;

FIG. 2 is a 3D view of the positioning mechanism, door railing body, and locking mechanism;

FIG. 3 is a sectional view of the present invention;

FIG. 4 is a schematic diagram from the first angle of the upper part of pivot connection side, the first connecting member, first top spring, limit seat, and connecting piece;

FIG. 5 is a schematic diagram from the second angle of the upper part of pivot connection side, the first connecting member, first top spring, limit seat, and connecting piece;

FIG. 6 is a sectional view of the sleeve in conjunction with the slot;

FIG. 7 is an exploded view of the locking mechanism;

FIG. 8 is an exploded view of the positioning mechanism;

FIG. 9 is a schematic diagram of the lower part of the pivot connection side and the second connecting piece;

FIG. 10 is a schematic diagram of the upper part of locking side, the third connecting member, and the locking member;

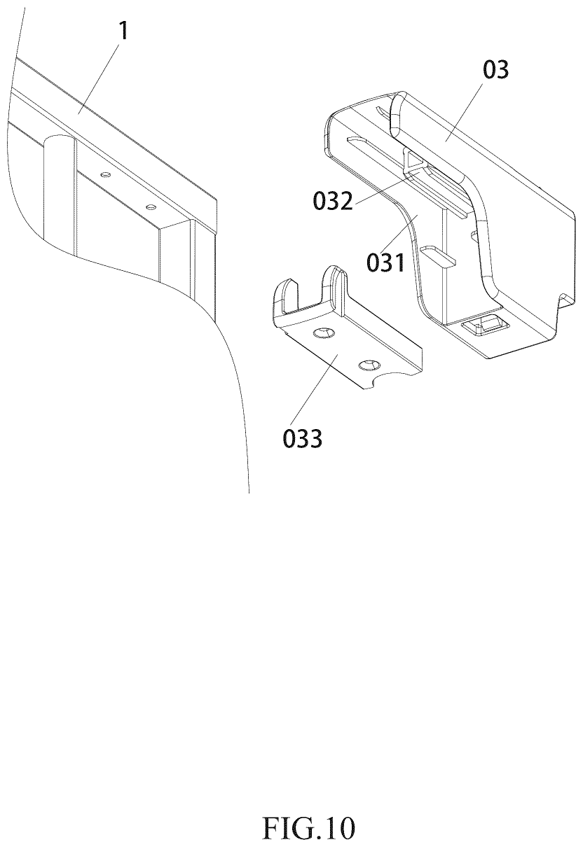

FIG. 11 is a schematic diagram of the lower part of locking side and the fourth connecting member.

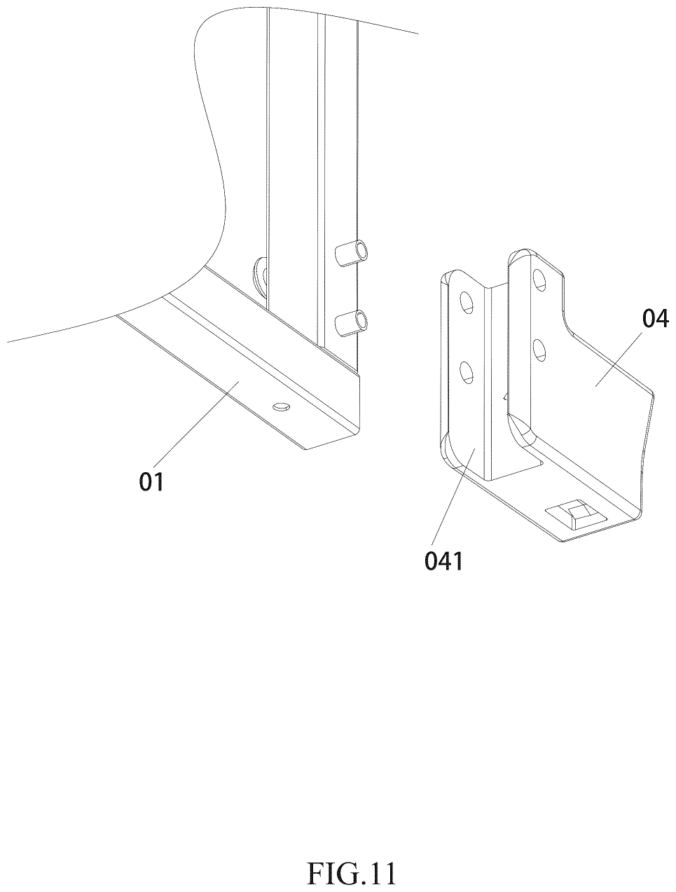

### DETAILED DESCRIPTION OF THE EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, horizontal, vertical, counterclockwise, clockwise, circumferential, radial, axial . . . ) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

The invention proposes a new type of protective sliding door.

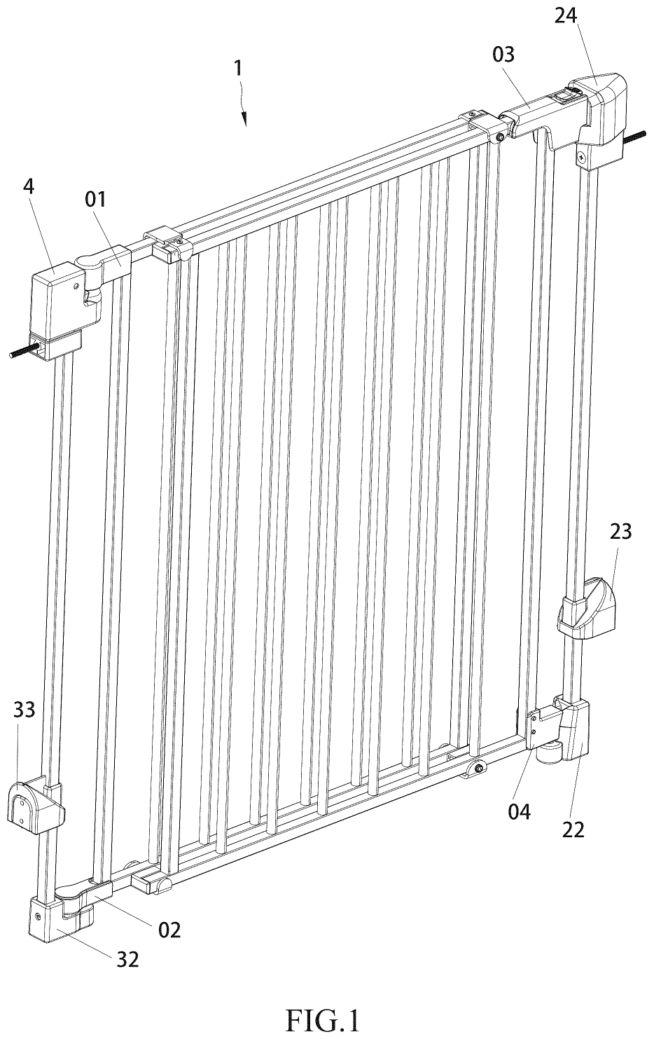

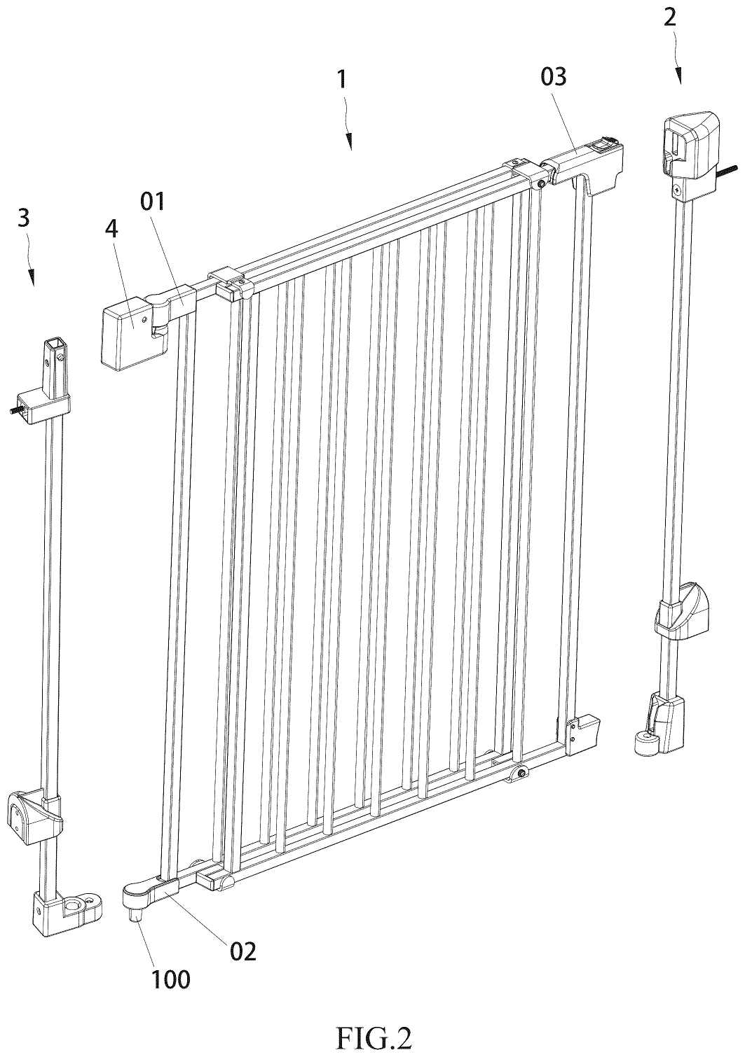

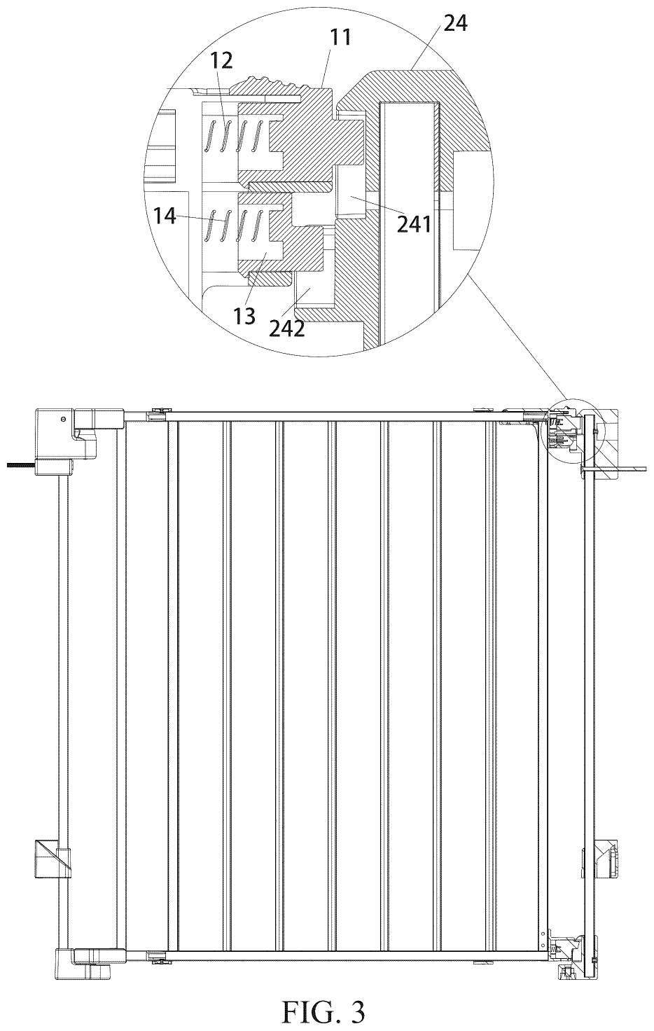

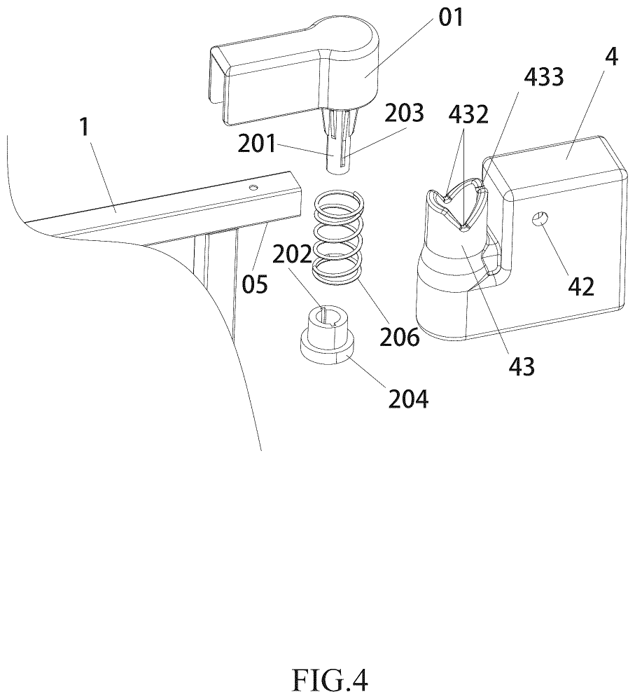

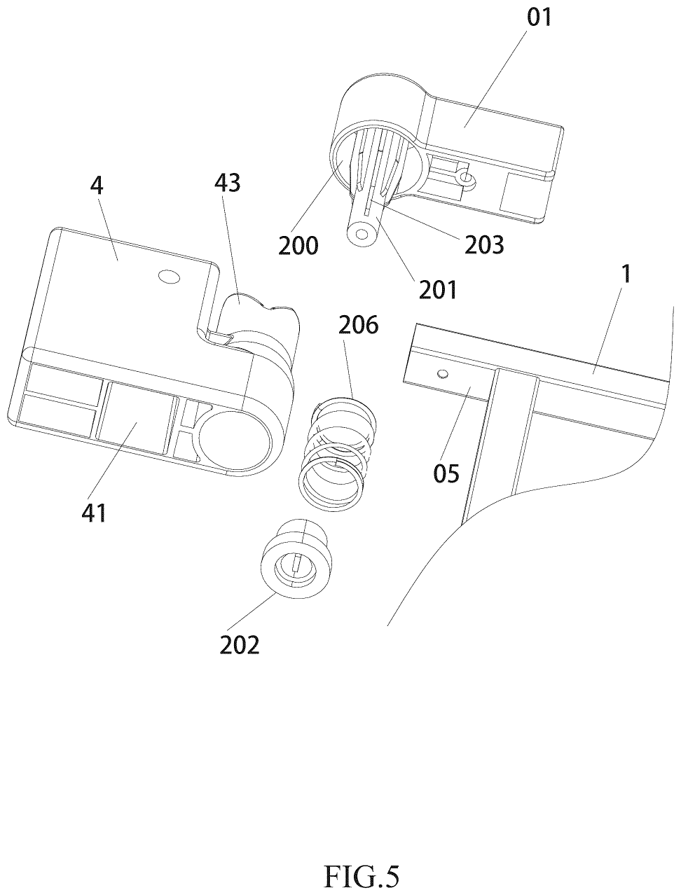

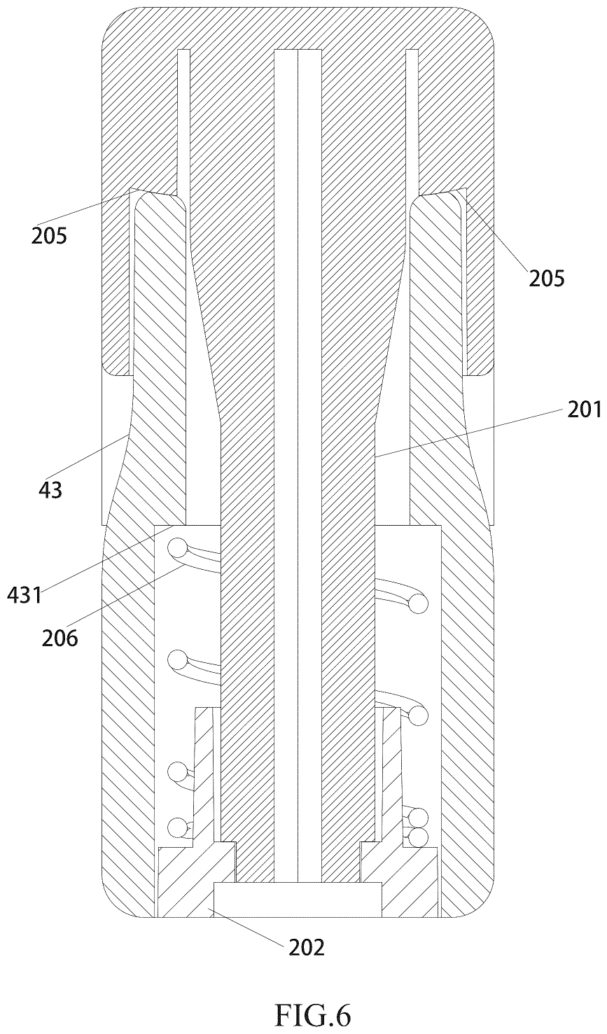

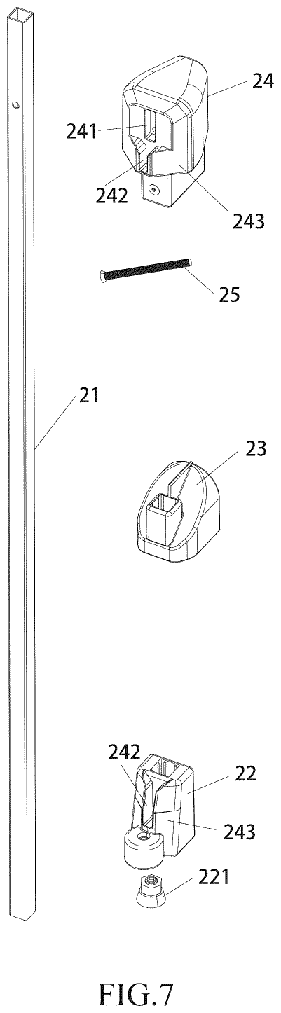

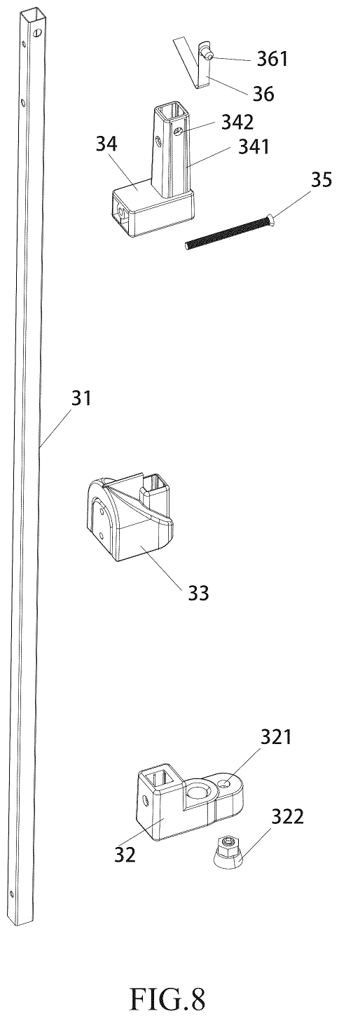

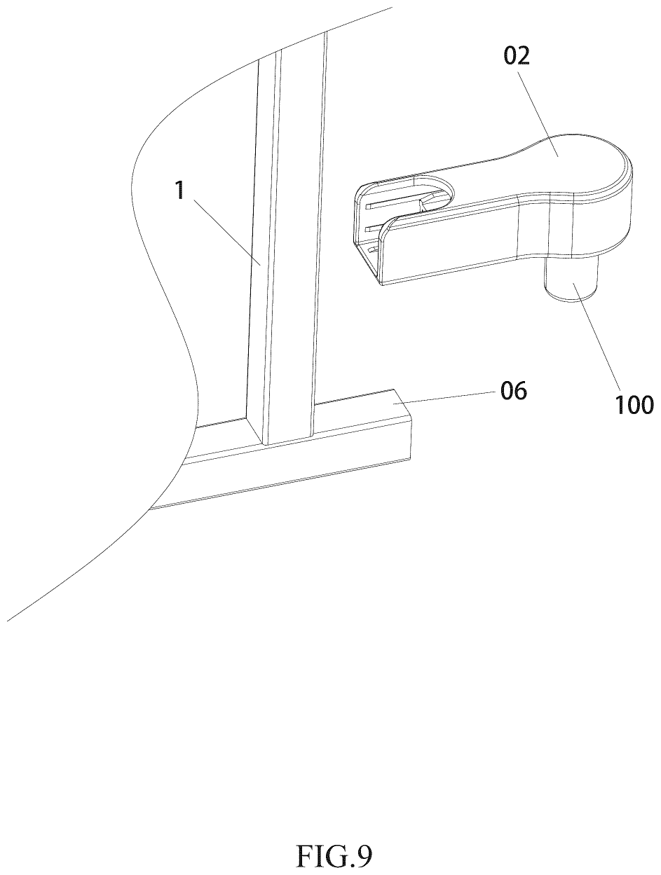

In the embodiments of the invention, as shown in FIGS. 1 to 9, the new type of protective sliding door includes a door railing body 1, a locking mechanism 2 located on the locking side of the door railing body 1, and a positioning mechanism 3 located on the pivot connection side of the door railing body 1, the door railing body includes a first door body having the pivot connection side and a second door body having the locking side, the first door body and the second door body are movably connected, and the second door body can move between the position where it overlaps the first door body and the position where it is staggered from the first door body, and the first door body and second door body are both formed by a plurality of connected bar components and have a plurality of hollows, the upper and lower parts of the pivot connection side are respectively provided with a first connecting member 01 and a second connecting member 02, and the second connecting member 02 is detachably connected to the lower part of the positioning mechanism 3, the first connecting member 01 can be pivotally provided with a connecting piece 4 for detachable and fixed assembly with the upper part of positioning mechanism 3, the door railing body can perform horizontal swing relative to the positioning mechanism, and the locking side can, along with the swing of the door railing body, swing between the position where it is locked with the locking mechanism and the position where it is away from the locking mechanism.

For the technical solution of the invention, during installation, the positioning mechanism and the locking mechanism can be first fixedly installed in a predetermined position, and then the door railing body can be installed, the lower part of the door railing body's pivot connection side can be flexibly connected to the lower part of the positioning mechanism, and the connecting piece that can be installed on the upper part of the door railing body's pivot connection side can be fixedly assembled with the upper part of the positioning mechanism, so that the installed door railing body can open or close the door by swinging relative to the positioning mechanism and, after the door is closed, the door railing body can be locked by the locking mechanism fixed in another position; compared with traditional sliding doors, the present invention optimizes the installation process, and makes the single-person installation easy and convenient, free of re-installation, effectively improving the installation efficiency.

Specifically, the positioning mechanism 3 includes a first support rod 31, a first lower seat 32 provided at the lower end of the first support rod 31, and a first sliding seat 33 movably sleeved on the first support rod 31, the connecting piece 4 is provided with an open-bottom connecting hole 41 for bottom-up insertion of the upper end of the first support rod 31, the first sliding seat 33 is detachably and fixedly connected to the wall through a first quick release structure to fix the first support rod 31, and the first lower seat 32 is provided with an open-top insertion hole 321, the lower part of the pivot connection side is provided with a pin 100 for movable insertion with the socket 321. For a wall with a skirting line during the installation of positioning mechanism 3, as the wall that is no longer in the same plane as skirting line is not suitable for installation, the first slider and the wall can be connected to keep the first lower seat 32 and the first support rod 31 away from the skirting line, thus avoiding the problem of difficult installation of positioning mechanism 3.

It should be noted that reference can be made to prior art for the first quick release structure, and its specific structural principle will not be elaborated here.

Specifically, the lower end of the first support rod 31 is connected and fitted with the first lower seat 32, and then locked with a bolt.

Specifically, the upper end of the first support rod 31 is sleeved with an L-shaped connecting seat 34, and further provided with a first screw 35, the rod portion of the first screw 35 sequentially passes through the connecting seat 34 and the first support rod 31 to maintain fixed connection to the wall, so that the upper end of the first support rod 31 and the wall are fixedly connected, and the upper part of the connecting seat 34 is inserted into the connecting hole 41. Specifically, the outer wall of the connecting seat 34 is provided with several stripes 341 for elastic contact with the inner wall of the connecting hole 41, so as to achieve interference fit between the connecting seat 34 and the connecting hole 41.

Specifically, the first support rod 31 is a hollow tubular member, and a V-shaped elastic member 36 is provided at the position inside the first support rod 31 corresponding to the connecting seat 34, one end of the elastic member 36 is provided with an exposed fixture block 361 that can pass through the first support rod 31, the position on the connecting seat 34 and the connecting piece 4 corresponding to the fixture block 361 is respectively provided with a first through hole 342 and a second through hole 42 that the fixture block 361 can pass through, and after the upper part of the connecting seat 34 is inserted into the connecting hole 41, the fixture block 361 passes through the first through hole 342 and the second through hole 42 sequentially to lock the connecting piece 4, connecting seat 34, and first support rod 31. If unlocking is necessary, the fixture block 361 can be compressed externally to exit the second through hole 42 to release the lock between the connecting piece 4 and the connecting seat 34, and when the fixture block 361 is forced to exit the first through hole 342, the lock between the connecting seat 34 and the first support rod 31 can be released.

Specifically, a sleeve 43 with a top opening and a bottom opening is provided on one side of the connecting piece 4 close to the pivot connection side, a slot 200 is provided on the upper part of the pivot connection side for the flexible bottom-up insertion of upper end of the sleeve 43, and an insertion column 201 that can extend into the sleeve 43 is provided in the slot 200, the end of the insertion column 201 is connected to a limit seat 202, and a step 431 that is pressed against the limit seat 202 is formed above the limit seat 202 corresponding to the inner wall of the sleeve 43, the door railing body 1 can perform vertical reciprocating motion relative to the connecting piece 4 to make the limit seat 202 contact or move away from the step 431.

Specifically, the limit seat 202 is locked with screws at the end of the insertion column 201.

Specifically, the outer wall of the insertion column 201 is provided with a limit strip 203 extending along the length direction of the insertion column 201, the limit seat 202 is fixedly sleeved at the end of the insertion column 201, and the inner wall of the limit seat 202 is provided with a strip groove 204 for plug insertion with the limit strip 203, so as to avoid pivot rotation of the limit seat 202 relative to the socket.

Specifically, V-shaped first limit position 432 and a second limit position 433 are annularly spaced on the upper end of the sleeve 43, the depth of the second limit position 433 is less than that of the first limit position 432, and the inner wall of the slot 200 is provided with a latch 205 that fits the first limit position 432, the latch 205 can, with the swing of the door barrier body 1, move between the position where it is aligned with the first limit position 432 and the position where it is aligned with the second limit position 433, and can snap into or exit the first limit position 432 or partially snap into or exit the second limit position 433 along with the vertical reciprocating motion of door railing body 1, and a first top spring 206 is also provided and is sleeved on the insertion column 201, and the two ends of the first top spring 206 are elastically pressed against the step 431 and limit seat 202, and the first top spring 206 can apply downward force to the door railing body 1. When the latch 205 is located at the first limit position 432, the door railing body 1 is in the closed position and, during the process of door opening, it is necessary to first release the lock mechanism 2, lift the door railing body 1, and then swing the door railing body 1, for example, swing the door railing body 1 90° to align the latch 205 with the second limit position 433, and release the door railing body 1 to let it fall, so that the latch 205 can partially engage with the second limit position 433 for limit purpose, maintaining the door railing body 1 at open position for a long time. For door closing, due to the shallow depth of the second limit position 433, the door railing body 1 can be directly swung to move upwards through the fitness between the latch 205 and the V-shaped structure of second limit position 433, causing the latch 205 to detach from the second limit position 433 and then, the elastic force applied by the first top spring 206, in combination with the latch 205 and the V-shaped structure of the first card position 432, can make the latch 205 quickly engage in the first limit position 432, so that the operator can allow the door railing body 1 automatically swing to close the door by slightly swinging the door railing body 1.

Specifically, the number of first limit position 432 is two, and the two first limit positions 432 are aligned with each other, and the second limit position 433 is located at the upper end of the sleeve 43 corresponding to the position between the two first limit positions 432 and, similarly, the number of snatch 205 is two.

Specifically, the first lower seat 32 is movably connected to a first fastener 322, and the first fastener 322 can move between the position where it is partially close contact with the ground and the position where it is separated from the ground. After the upper end of the first support rod 31 is fixed with the first screw 35, the first lower seat 32 can also be fixed to the ground by pressing the first fastener 322 against the ground.

Specifically, the locking mechanism 2 includes a second support rod 21, a second lower seat 22 located at the lower end of the second support rod 21, a second sliding seat 23 that is movably sleeved on the second support rod 21, and a locking seat 24 located at the upper end of the second support rod 21, and the second sliding seat 23 maintains detachable fixed connection with the wall through a second quick release structure to fix the second support rod 21, and the upper part of the locking side is provided with a first expansion member 11 having a driving portion, a first limit hole 241 is provided at the position on the locking seat 24 corresponding to the first expansion member 11, the first expansion member 11 can move between the position where it partially extends into the first limit hole 241 and the position where it exits and, additionally, a second top spring 12 is provided to apply elastic force to the first expansion member 11 so that the first expansion member 11 can move and partially extend into the first limit hole 241. When the first expansion member 11 partially extends into the first limit hole 241, the door railing body 1 and the locking seat 24 can be locked, and unlocking is realized by manually pushing the driving portion to force the first expansion member 11 partially exit from the first limit hole 241.

It should be noted that reference can be made to prior art for the first quick release structure, and its specific structural principle will not be elaborated here.

Specifically, the lower end of the second support rod 21 is connected and fitted with the second lower seat 22, and then locked with a bolt.

Specifically, the second support rod 21 is a tubular structure.

Specifically, according to the technical feature that the door railing body 1 can move within a certain range in the vertical direction, a second expansion member 13 is provided at a position below the first expansion member 11 on the upper part of the locking side, and a second limit hole 242 is provided at a position on the locking seat 24 corresponding to the second expansion member 13, the second limit hole 242 has a front side opening and a top opening, and the second expansion member 13 can move between the position where it extends partially into the second limit hole 242 and the position where it is far away from the second limit hole 242, and a third top spring 14 is also provided to apply elastic force to the second expansion member 13 so that the second expansion member 13 can move and partially extend into the second limit hole 242, an inclined surface 243 is provided on one side of the locking seat 24 near the second expansion member 13. To unlock the door railing body 1, manually force the first expansion member 11 to partially exit the first limit hole 241, and then lift the entire door railing body 1 upwards to partially detach the second expansion member 13 from the second limit hole 242 through the top opening of the second limit hole 242, in order to unlock the door railing body 1. To lock the door railing body 1, the door railing body 1 can come into contact with the second expansion member 13 through the inclined surface 243 during the swing process and, during the process, force the second expansion member 13 to move away from the second limit hole 242 until the second expansion member 13 aligns with the front opening of second limit hole 242, and the elastic force applied by the third top spring 14 to the second expansion member 13 makes the second expansion member 13 partially extend into the second limit hole 242 to realize secondary locking, so that the door railing body 1 would not be easily unlocked by infants.

Understandably, the inclined surface 243 can also come into contact with the first expansion member 11 and force the first expansion member 11 to move away from the first limit hole 241.

Specifically, the lower part of the locking side is provided with the second expansion member 13 and the third top spring 14, and the second lower seat 22 is provided with the second limit hole 242 and the inclined surface 243.

Specifically, the upper end of the second support rod 21 is locked by a second screw 25 after connection and fitted with the locking seat 24, the second screw 25 can further be rotatably connected to the wall to maintain a fixed connection between the upper end of second support rod 21 and the wall, the second lower seat 22 is movably connected to a second fastener 221, and the second fastener 221 can move between the position where it is partially close contact with the ground and the position where it is separated from the ground.

Specifically, the first fastener 322 and the second fastener 221 have the same structure, and can be bolts, and tight contact with the ground is realized through the end of the bolt, or a pressure block is fixedly connected to the end of the bolt, and the pressure block can be in tight contact with the ground or separated from the ground along with the pivot of the bolt.

Specifically, the third connecting member 03 is provided with a first slot 031 that can cover the upper part of the locking side, the first slot 031 is provided with an insertion block 032 that can be plug connected with the upper part of the locking side, the third connecting member 03 covers the upper part of the locking side through the first slot 031 and inserts the insertion block 032 into the upper part of the locking side, and the opening side of the first slot 031 is also provided with a locking member 033 that covers the upper part of the locking side away from the first slot 031, and the locking member 033, upper part of the locking side and the third connecting member 03 are locked with screws; a second slot 041 is provided on the side of the fourth connecting member 04 away from the second lower seat, and the fourth connecting member 04 is locked by screws after being engaged with the lower part of locking side through the second slot 041.

It should be noted that reference can be made to prior art for the mutual movable connection between the first door body and the second door body, and its specific structural principle will not be elaborated here.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

What is claimed is:

1. A new type of protective sliding door, including a door railing body (1), a locking mechanism (2) located on the locking side of the door railing body (1), and a positioning mechanism (3) located on the pivot connection side of the door railing body (1), the door railing body includes a first door body having the pivot connection side and a second door body having the locking side, the first door body and the second door body are movably connected, and the second door body can move between the position where it overlaps the first door body and the position where it is staggered from the first door body, and the first door body and second door body are both formed by a plurality of connected bar components and have a plurality of hollows, the upper and lower parts of the pivot connection side are respectively provided with a first connecting member (01) and a second connecting member (02), and the second connecting member (02) is detachably connected to the lower part of the positioning mechanism (3), the first connecting member (01) can be pivotally provided with a connecting piece (4) for detachable and fixed assembly with the upper part of positioning mechanism (3), the door railing body can perform horizontal swing relative to the positioning mechanism, and the locking side can, along with the swing of the door railing body, swing between the position where it is locked with the locking mechanism and the position where it is away from the locking mechanism.

2. The new type of protective sliding door according to claim 1, wherein the positioning mechanism (3) includes a first support rod (31), a first lower seat (32) provided at the lower end of the first support rod (31), and a first sliding seat (33) movably sleeved on the first support rod (31), the connecting piece (4) is provided with an open-bottom connecting hole (41) for bottom-up insertion of the upper end of the first support rod (31), the first sliding seat (33) is detachably and fixedly connected to the wall through a first quick release structure to fix the first support rod (31), and the first lower seat (32) is provided with an open-top insertion hole (321), and the bottom wall of the second connecting member (02) is provided with a pin (100) for pivotable insertion with the socket (321).

3. The new type of protective sliding door according to claim 2, wherein the upper end of the first support rod (31) is sleeved with an L-shaped connecting seat (34), and further provided with a first screw (35), the rod portion of the first screw (35) sequentially passes through the connecting seat (34) and the first support rod (31) to maintain fixed connection to the wall, so that the upper end of the first support rod (31) and the wall are fixedly connected, and the upper part of the connecting seat (34) is inserted into the connecting hole (41).

4. The new type of protective sliding door according to claim 3, wherein the first support rod (31) is a hollow tubular member, and a V-shaped elastic member (36) is provided at the position inside the first support rod (31) corresponding to the connecting seat (34), one end of the elastic member (36) is provided with an exposed fixture block (361) that can pass through the first support rod (31), the position on the connecting seat (34) and the connecting piece (4) corresponding to the fixture block (361) is respectively provided with a first through hole (342) and a second through hole (42) that the fixture block (361) can pass through, and after the upper part of the connecting seat (34) is inserted into the connecting hole (41), the fixture block (361) passes through the first through hole (342) and the second through hole (42) sequentially to lock the connecting piece (4), connecting seat (34), and first support rod (31).

5. The new type of protective sliding door according to claim 1, wherein a sleeve (43) with a top opening and a bottom opening is provided on the connecting piece (4), a slot (200) is provided on the first connecting member (01) for the flexible bottom-up insertion of the sleeve (43), and an insertion column (201) that can extend into the sleeve (43) is provided in the slot (200), the end of the insertion column (201) is connected to a limit seat (202), and a step (431) that is pressed against the limit seat (202) is formed above the limit seat (202) corresponding to the inner wall of the sleeve (43), the door railing body (1) can perform vertical reciprocating motion relative to the connecting piece (4) to make the limit seat (202) contact or move away from the step (431).

6. The new type of protective sliding door according to claim 5, wherein the outer wall of the insertion column (201) is provided with a limit strip (203) extending along the length direction of the insertion column (201), the limit seat (202) is fixedly sleeved at the end of the insertion column (201), and the inner wall of the limit seat (202) is provided with a strip groove (204) for plug insertion with the limit strip (203).

7. The new type of protective sliding door according to claim 5, wherein V-shaped first limit position (432) and a second limit position (433) are annularly spaced on the upper end of the sleeve (43), the depth of the second limit position (433) is less than that of the first limit position (432), and the inner wall of the slot (200) is provided with a latch (205) that fits the first limit position (432), the latch (205) can, with the swing of the door barrier body (1), move between the position where it is aligned with the first limit position (432) and the position where it is aligned with the second limit position (433), and can snap into or exit the first limit position (432) or partially snap into or exit the second limit position (433) along with the vertical reciprocating motion of door railing body (1), and a first top spring (206) is also provided and is sleeved on the insertion column (201), and the two ends of the first top spring (206) are elastically pressed against the step (431) and limit seat (202), and the first top spring (206) can apply downward force to the door railing body (1).

8. The new type of protective sliding door according to claim 2, wherein the first lower seat (32) is movably connected to a first fastener (322), and the first fastener (322) can move between the position where it is partially close contact with the ground and the position where it is separated from the ground.

9. The new type of protective sliding door according to claim 1, wherein the locking mechanism (2) includes a second support rod (21), a second lower seat (22) located at the lower end of the second support rod (21), a second sliding seat (23) that is movably sleeved on the second support rod (21), and a locking seat (24) located at the upper end of the second support rod (21), and the second sliding seat (23) maintains detachable fixed connection with the wall through a second quick release structure to fix the second support rod (21), and the upper part and lower part of the locking side are respectively provided with the third connecting member (03) and the fourth connecting member (04), the third connecting member (03) is provided with a first expansion member (11) having a driving portion, a first limit hole (241) is provided at the position on the locking seat (24) corresponding to the first expansion member (11), the first expansion member (11) can move between the position where it partially extends into the first limit hole (241) and the position where it exits and, additionally, a second top spring (12) is also provided to apply elastic force to the first expansion member (11) so that the first expansion member (11) can move and partially extend into the first limit hole (241).

10. The new type of protective sliding door according to claim 9, wherein a second expansion member (13) is provided at a position below the first expansion member (11) corresponding to the third connecting member (03), and a second limit hole (242) is provided at a position on the locking seat (24) corresponding to the second expansion member (13), the second limit hole (242) has a front side opening and a top opening, and the second expansion member (13) can move between the position where it extends partially into the second limit hole (242) and the position where it is far away from the second limit hole (242), and a third top spring (14) is also provided to apply elastic force to the second expansion member (13) so that the second expansion member (13) can move and partially extend into the second limit hole (242), an inclined surface (243) is provided on one side of the locking seat (24) near the second expansion member (13).

11. The new type of protective sliding door according to claim 10, wherein the fourth connecting member (04) is provided with the second expansion member (13) and the third top spring (14), and the second lower seat (22) is provided with the second limit hole (242) and the inclined surface (243).

12. The new type of protective sliding door according to claim 9, wherein the upper end of the second support rod (21) is locked by a second screw (25) after connection and fitted with the locking seat (24), the second screw (25) can further be rotatably connected to the wall to maintain a fixed connection between the upper end of second support rod (21) and the wall, the second lower seat (22) is movably connected with a second fastener (221), and the second fastener (221) can move between the position where it is partially close contact with the ground and the position where it is separated from the ground.

13. The new type of protective sliding door according to claim 1, wherein the first door body extends outward to form a first extending portion (05) and a second extending portion (06), and the first connecting member (01) and the second connecting member (02) are respectively inserted into the first extending portion (05) and the second extending portion (06) and locked by screws.

14. The new type of protective sliding door according to claim 9, wherein the third connecting member (03) is provided with a first slot (031) that can cover the upper part of the locking side, the first slot (031) is provided with an insertion block (032) that can be plug connected with the upper part of the locking side, the third connecting member (03) covers the upper part of the locking side through the first slot (031) and inserts the insertion block (032) into the upper part of the locking side, and the opening side of the first slot (031) is also provided with a locking member (033) that covers the upper part of the locking side away from the first slot (031), and the locking member (033), upper part of the locking side and the third connecting member (03) are locked with screws; a second slot (041) is provided on the side of the fourth connecting member (04) away from the second lower seat, and the fourth connecting member (04) is locked by screws after being engaged with the lower part of locking side through the second slot (041).
